(19) United States
(12) Patent Application Publication
(10) Pub. No.: US 2026/0048718 A1
(43) Pub. Date: Feb. 19, 2026

(54) WINDSHIELD WIPER LIFTING SYSTEM

(71) Applicant: Adam Sas, Lorain, OH (US)

(72) Inventor: Adam Sas, Lorain, OH (US)

(21) Appl. No.: 18/978,039

(22) Filed: Dec. 12, 2024

Related U.S. Application Data
(60) Provisional application No. 63/682,379, filed on Aug. 13, 2024.

(51) Int. Cl. B60S 1/34; B60S 1/08; B60S 1/20; F16H 19/08

(52) U.S. Cl. CPC B60S 1/3413; B60S 1/08; B60S 1/20; F16H 19/08; F16H 2019/085

(57) ABSTRACT

A windshield wiper lifting system is provided. The system is used for controlling the position of a vehicle windshield wiper by lifting the wiper above a windshield using a motorized cable mechanism. The system comprises at least one motor that rotates a spool, which winds or unwinds a corrosion-resistant cable attached to the wiper. The cable includes a fastener on one end for removable attachment to the wiper, and the other end is connected to the spool. The motor, powered by the vehicle's electrical system, adjusts the cable tension to lift or lower the wiper as needed. A control button within the vehicle activates the motor, allowing the user to manipulate the wiper from inside the vehicle.

### CROSS-REFERENCE TO RELATED APPLICATION

The present application claims priority to, and the benefit of, U.S. Provisional Application No. 63/682,379, which was filed on Aug. 13, 2024, and is incorporated herein by reference in its entirety.

### FIELD OF THE INVENTION

The present invention relates generally to the field of windshield wipers. More specifically, the present invention relates to a windshield wiper lifting system that provides a cable system attached to a windshield wiper that allows the wiper to be lifted from a windshield from inside the vehicle via a button. Accordingly, the present disclosure makes specific reference thereto. Nonetheless, it is to be appreciated that aspects of the present invention are also equally applicable to other like applications, devices, and methods of manufacture.

### BACKGROUND

During inclement weather conditions, such as snow, sleet, or freezing rain, various types of debris and ice can easily accumulate underneath a vehicle's windshield wipers. This debris often consists of snow, ice, dirt, and small branches that can get lodged beneath the wipers as they sit idle on the windshield. When temperatures drop, the moisture in the snow and sleet can freeze, causing the wipers to become stuck or frozen to the windshield. As a result, the wipers are rendered immobile and cannot be used effectively until the vehicle's interior has warmed up sufficiently to melt the ice and loosen the wipers from their frozen state. This process can take several minutes, or even longer, depending on the severity of the weather and the efficiency of the vehicle's heating system.

If a driver attempts to activate the windshield wipers while they are still frozen to the windshield, the rubber portion of the wiper blade can easily tear away from the wiper arm. This not only compromises the effectiveness of the wipers but also leads to decreased visibility during adverse weather conditions, posing a significant safety hazard. Additionally, the damage to the wipers may necessitate costly repairs or replacements, which can be an unexpected expense for the vehicle owner. In some cases, the strain of forcing frozen wipers to move can also damage the wiper motor or other components of the wiper system, further adding to repair costs.

Moreover, the process of getting out of a warm vehicle and into the cold to manually lift and free the wipers from the frozen windshield can be both inconvenient and uncomfortable for the driver. This is especially true during severe winter conditions when temperatures are extremely low, and wind chills can make the situation even more challenging. Drivers may have to scrape away ice and snow buildup with their hands or use a windshield scraper, both of which are time-consuming and can cause cold, wet hands. The task of manually freeing the wipers can be particularly frustrating during early morning commutes or late-night drives when drivers are in a hurry or are already fatigued.

The frustration of dealing with frozen windshield wipers is a common experience for many drivers during the winter months. It adds another layer of stress to an already challenging driving situation, as inclement weather often leads to reduced visibility, slippery road conditions, and increased potential for accidents.

Therefore, there exists a long-felt need in the art for a system the eliminates frustration caused by windshield wipers sticking to a windshield during cold weather. There also exists a long-felt need in the art for a windshield wiper lifting system that allows a user to lift windshield wipers off of a windshield such that they do not freeze to the windshield. More specifically, there exists a long-felt need in the art for a windshield wiper lifting system that allows a user to lift windshield wipers off of a windshield such that they do not freeze to the windshield, wherein the system allows a user to lift the wipers without having to do so from outside of the vehicle.

The subject matter disclosed and claimed herein, in one embodiment thereof, comprises a windshield wiper lifting system. The system is used for controlling the position of a vehicle windshield wiper by lifting the wiper above a windshield using a motorized cable mechanism. The system comprises at least one motor that rotates a spool, which winds or unwinds a corrosion-resistant cable attached to the wiper. The cable includes a fastener on one end for removable attachment to the wiper, and the other end is connected to the spool. The motor, powered by the vehicle's electrical system, adjusts the cable tension to lift or lower the wiper as needed. A control button within the vehicle activates the motor, allowing the user to manipulate the wiper from inside the vehicle.

In this manner, the windshield wiper lifting system of the present invention accomplishes all the forgoing objectives and provides a system that eliminates the frustration caused by windshield wipers sticking to a windshield during cold weather. To do so, the system allows a user to lift windshield wipers off of a windshield such that they do not freeze to the windshield. More specifically, the system allows a user to lift the wipers without having to do so from outside of the vehicle, thus enhancing user convenience and comfort.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a windshield wiper lifting system. The system is comprised of at least one motor that rotates at least one cable around at least one spool. More specifically, a first end of the cable is comprised of at least one fastener that may be fixedly or removably attached to the cable. The fastener allows the cable to removably attach to a windshield wiper of a vehicle. The second end of the cable is fixedly or removably attached to at least one spool that is attached to and can be rotated clockwise and counterclockwise by at least one motor. The motor is preferably an electric motor powered by an existing electrical power supply of the vehicle the system is installed within. The motor may be attached anywhere within a vehicle. To allow the motor (and/or spool) to attach to a location of the vehicle, the system is comprised of at least one fastener.

When the motor rotates the spool in a first direction (ex. counterclockwise) the cable is wound around the spool such that the cable decreases in length and in turn lifts the wiper off of a windshield via the tension of the cable. When the motor rotates the spool in a second direction (ex. clockwise) that is opposite of the first direction, the cable is unwound from the spool such that the cable increases in length and in turn the wiper falls onto the vehicle windshields and rests on the windshield such that the wiper can operate normally (wherein there is slack in the cable to allow the same to occur). Controlling the activation and rotation direction of the motor may be controlled via at least one button. The button is preferably positioned within the interior of the vehicle the system is installed within, such that a user can raise and lower the wiper from the windshield as desired from within the vehicle.

The present invention is also comprised of a method of using the device. First, a system is provided comprised of a spool attached to a motor, a cable attached to the spool and comprised of a fastener, and a button that controls the motor. Then, the fastener can be attached to a windshield wiper of a vehicle while the cable is attached to the fastener, wherein the cable can then be fed into the engine bay of the vehicle through the hood or other area. Next, the motor and/or spool can be attached to an area within the engine bay (or other area) via at least one fastener. Next, a button in electrical communication with the motor can be installed within an interior of the vehicle. Then, the button can be pressed a first time to spin the spool (via the motor) in a first direction to tighten the cable and pull the wiper off of the windshield. Finally, a user can press the button a second time to spin the spool (via the motor) in a second direction to loosen the cable to allow the wiper to rest back onto the windshield and to operate as normal.

Accordingly, the windshield wiper lifting system of the present invention is particularly advantageous as it provides a system that eliminates the frustration caused by windshield wipers sticking to a windshield during cold weather. To do so, the system allows a user to lift windshield wipers off of a windshield such that they do not freeze to the windshield. More specifically, the system allows a user to lift the wipers without having to do so from outside of the vehicle, thus enhancing user convenience and comfort. In this manner, the windshield wiper lifting system provides a solution to keeping windshield wipers from freezing from a vehicle windshield in a user-friendly manner.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a windshield wiper lifting system of the present invention with a windshield wiper of a vehicle being lifted above a windshield via the system in accordance with the disclosed architecture;

FIG. 2 illustrates a perspective view of one potential embodiment of a windshield wiper lifting system of the present invention attached to a windshield wiper of a vehicle in accordance with the disclosed architecture; and

FIG. 3 illustrates a flowchart of a method of using one potential embodiment of a windshield wiper lifting system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system the eliminates frustration caused by windshield wipers sticking to a windshield during cold weather. There also exists a long-felt need in the art for a windshield wiper lifting system that allows a user to lift windshield wipers off of a windshield such that they do not freeze to the windshield. More specifically, there exists a long-felt need in the art for a windshield wiper lifting system that allows a user to lift windshield wipers off of a windshield such that they do not freeze to the windshield, wherein the system allows a user to lift the wipers without having to do so from outside of the vehicle.

The present invention, in one exemplary embodiment, is comprised of a windshield wiper lifting system comprised of at least one motor that rotates at least one cable around at least one spool. More specifically, a first end of the cable is comprised of at least one fastener that may be fixedly or removably attached to the cable, wherein the fastener allows the cable to removably attach to a windshield wiper of a vehicle. The second end of the cable is fixedly or removably attached to at least one spool that is attached to and can be rotated clockwise and counterclockwise by at least one motor. The motor is preferably an electric motor powered by an existing electrical power supply of the vehicle the system is installed within. The motor may be attached anywhere within a vehicle. To allow the motor (and/or spool) to attach to a location of the vehicle, the system is comprised of at least one fastener.

When the motor rotates the spool in a first direction (ex. counterclockwise) the cable is wound around the spool such that the cable decreases in length and in turn lifts the wiper off of a windshield via the tension of the cable. When the motor rotates the spool in a second direction (ex. clockwise) that is opposite of the first direction, the cable is unwound from the spool such that the cable increases in length and in turn the wiper falls onto the vehicle windshields and rests on the windshield such that the wiper can operate normally (wherein there is slack in the cable to allow the same to occur). Controlling the activation and rotation direction of the motor may be controlled via at least one button. The button is preferably positioned within the interior of the vehicle the system is installed within, such that a user can raise and lower the wiper from the windshield as desired from within the vehicle.

The present invention is also comprised of a method of using the device. First, a system is provided comprised of a spool attached to a motor, a cable attached to the spool and comprised of a fastener, and a button that controls the motor. Then, the fastener can be attached to a windshield wiper of a vehicle while the cable is attached to the fastener, wherein the cable can then be fed into the engine bay of the vehicle through the hood or other area. Next, the motor and/or spool can be attached to an area within the engine bay (or other area) via at least one fastener. Next, a button in electrical communication with the motor can be installed within an interior of the vehicle. Then, the button can be pressed a first time to spin the spool (via the motor) in a first direction to tighten the cable and pull the wiper off of the windshield. Finally, a user can press the button a second time to spin the spool (via the motor) in a second direction to loosen the cable to allow the wiper to rest back onto the windshield and to operate as normal.

Accordingly, the windshield wiper lifting system of the present invention is particularly advantageous as it provides a system that eliminates the frustration caused by windshield wipers sticking to a windshield during cold weather. To do so, the system allows a user to lift windshield wipers off of a windshield such that they do not freeze to the windshield. More specifically, the system allows a user to lift the wipers without having to do so from outside of the vehicle, thus enhancing user convenience and comfort. In this manner, the windshield wiper lifting system provides a solution to keeping windshield wipers from freezing from a vehicle windshield in a user-friendly manner.

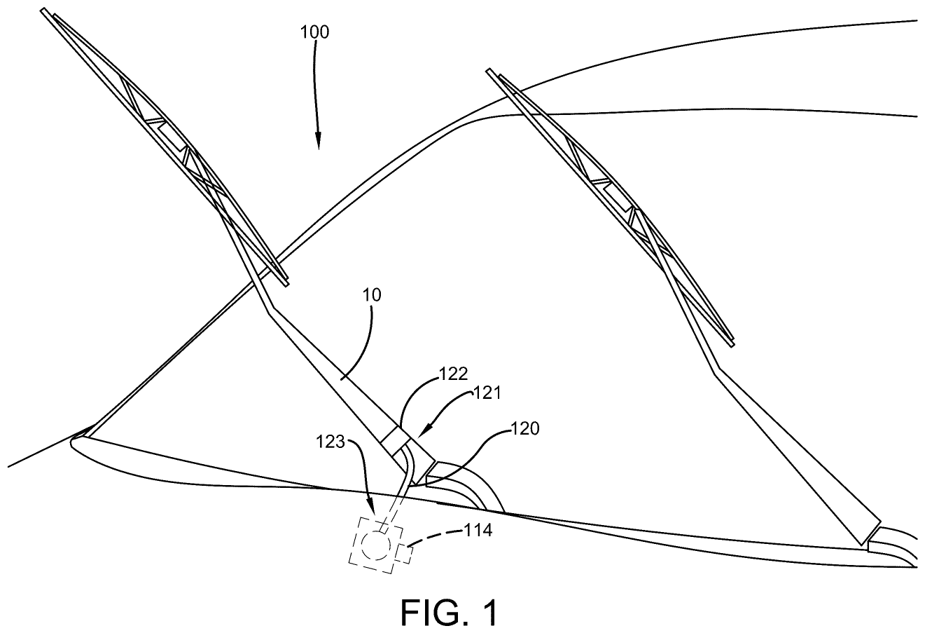

Referring initially to the drawings, FIG. 1 illustrates a perspective view of one potential embodiment of a windshield wiper lifting system 100 of the present invention with a windshield wiper of a vehicle being lifted above a windshield via the system in accordance with the disclosed architecture. The system 100 is comprised of at least one motor 110 that rotates at least one cable 120 around at least one spool 112. More specifically, the cable 120 is preferably comprised of a corrosion-resistant material, such as but not limited to a braided metal wire. A first end 121 of the cable 120 is comprised of at least one fastener 122 that may be fixedly or removably attached to the cable 120. The fastener 122 allows the cable 120 to removably attach to a windshield wiper 10 of a vehicle. The fastener 122 may be any configuration that allows for removable attachment to the wiper 10. For example, the fastener 122 may include but is not limited to a clip, a clamp, a magnet, a female fastener, a male fastener, a looped fastener, etc.

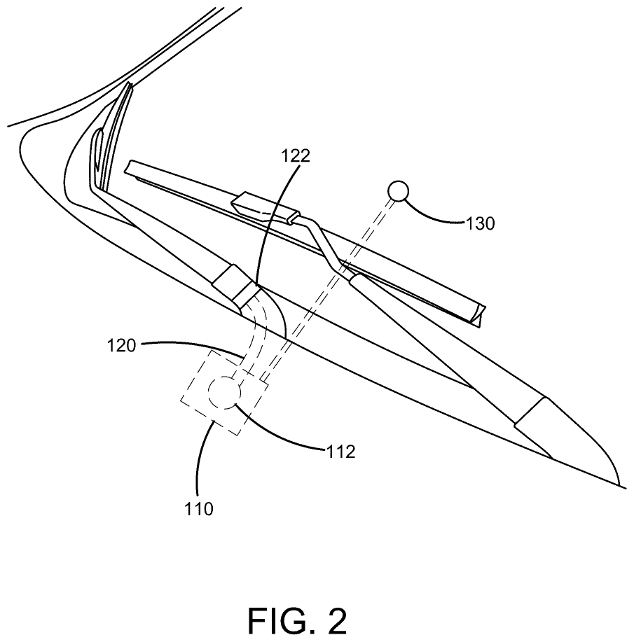

The second end 123 of the cable 120 is fixedly or removably attached to at least one spool 112. The spool 112 is attached to and can be rotated clockwise and counterclockwise by at least one motor 110. The motor 110 is preferably an electric motor powered by an existing electrical power supply of the vehicle the system 100 is installed within. When the motor 110 rotates the spool 112 in a first direction (ex. counterclockwise) the cable 120 is wound around the spool 112 such that the cable 120 decreases in length and in turn lifts the wiper 10 off of a windshield via the tension of the cable 120. When the motor 110 rotates the spool 112 in a second direction (ex. clockwise) that is opposite of the first direction, the cable 120 is unwound from the spool 112 such that the cable increases in length and in turn the wiper 10 falls onto the vehicle windshields and rests on the windshield such that the wiper can operate normally (wherein there is slack in the cable 120 to allow the same to occur), as seen in FIG. 2. The motor 110 can also be used to operate the windwheel wiper hinges to lift the wipers off of the windshield.

Controlling the activation and rotation direction of the motor 110 may be controlled via at least one button 130. The button 130 is preferably in wired or wireless electrical communication with the motor 110. The button 130 is preferably positioned within the interior of the vehicle the system 100 is installed within, such that a user can raise and lower the wiper 10 from the windshield as desired from within the vehicle. The button 130 may also be alternative controls such as but not limited to a switch, a lever, etc.

The motor 110 may be attached anywhere within a vehicle. This includes but is not limited to on the underside of a vehicle hood or anywhere within an engine bay within a vehicle. To allow the motor 110 (and/or spool 112) to attach to a location of the vehicle, the system 100 is comprised of at least one fastener 114. The fastener 114 may attach to the motor 110 and/or the spool 112. The fastener 114 may include but is not limited to a clip, a clamp, a magnet, a tie, a mounting bracket, etc. or any combination thereof.

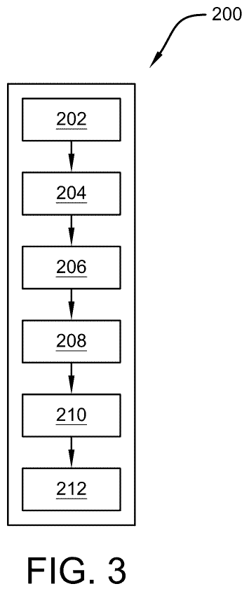

The present invention is also comprised of a method of using 200 the device 100, as seen in FIG. 3. First, a system 100 is provided comprised of a spool 112 attached to a motor 110, a cable 120 attached to the spool 112 and comprised of a fastener 122, and a button 130 that controls the motor 110 [Step 202]. Then, the fastener 122 can be attached to a windshield wiper 10 of a vehicle while the cable 120 is attached to the fastener 122, wherein the cable 120 can then be fed into the engine bay of the vehicle through the hood or other area and attached to the spool 112 [Step 204]. Next, the motor 110 and/or spool 112 can be attached to an area within the engine bay (or other area) via at least one fastener 114 [Step 206]. Next, a button 130 in electrical communication with the motor 110 can be installed within an interior of the vehicle [Step 208]. Then, the button 130 can be pressed a first time to spin the spool 112 (via the motor 110) in a first direction to tighten the cable 120 and pull the wiper 10 off of the windshield [Step 210]. Finally, a user can press the button 130 a second time to spin the spool 112 (via the motor 110) in a second direction to loosen the cable 120 to allow the wiper 10 to rest back onto the windshield and to operate as normal [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “windshield wiper lifting system” and “system” are interchangeable and refer to the windshield wiper lifting system 100 of the present invention.

Notwithstanding the forgoing, the windshield wiper lifting system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the windshield wiper lifting system 100 as shown in the FIGS. are for illustrative purposes only, and that many other sizes and shapes of the windshield wiper lifting system 100 are well within the scope of the present disclosure. Although the dimensions of the windshield wiper lifting system 100 are important design parameters for user convenience, the windshield wiper lifting system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A windshield wiper lifting system comprising:
a motor;
a button;
a spool attached to the motor;
a cable attached to the spool; and
a first fastener attached to the cable.

2. The windshield wiper lifting system of claim 1, wherein the first fastener is comprised of a clip, a clamp, a magnet, a female fastener, a male fastener, or a looped fastener.

3. The windshield wiper lifting system of claim 1, wherein the motor rotates the spool a first direction and a second direction.

4. The windshield wiper lifting system of claim 3, wherein the first direction is clockwise.

5. The windshield wiper lifting system of claim 3, wherein the second direction is counterclockwise.

6. The windshield wiper lifting system of claim 3, wherein the button is in wired electrical communication with the motor.

7. The windshield wiper lifting system of claim 1, wherein the button is in wired electrical communication with the motor.

8. The windshield wiper lifting system of claim 1, wherein the button controls whether the motor rotates the spool in the first direction or the second direction.

9. The windshield wiper lifting system of claim 1, wherein the motor is comprised of an electric motor.

10. The windshield wiper lifting system of claim 1, wherein the cable is comprised of a corrosion-resistant cable.

11. The windshield wiper lifting system of claim 1, wherein the cable is comprised of a metal-braided wire.

12. The windshield wiper lifting system of claim 1, wherein the motor is comprised of a second fastener.

13. The windshield wiper lifting system of claim 12, wherein the second fastener is comprised of a clip, a clamp, a magnet, a tie, or a mounting bracket.

14. A windshield wiper lifting system comprising:
a motor that rotates a first direction and a second direction;
a cable;
a button in electrical communication with the motor;
a spool attached to the motor, wherein a second end of the cable is attached to the spool; and
a fastener attached to a first end of the cable.

15. The windshield wiper lifting system of claim 14, wherein the fastener is removably attached to a first end of the cable.

16. The windshield wiper lifting system of claim 14, wherein a second end of the cable removably attaches to the spool.

17. The windshield wiper lifting system of claim 14, wherein the button is in wireless electrical communication with the motor.

18. A method of using a windshield wiper lifting system, the method comprising:
providing a windshield wiper lifting system comprised of a spool attached to a motor, a cable attached to the spool and comprised of a fastener, and a button that controls the motor;
attaching the fastener to a windshield wiper and a spool;
attaching the motor within an engine bay of a vehicle;
installing the button in an interior of the vehicle;
pressing the button to pull the windshield wiper upwards off a windshield via the cable; and
pressing the button to loosen the cable to allow the windshield wiper to rest back onto the windshield.

19. The method of using a windshield wiper lifting system of claim 18, wherein the motor rotates the spool a first direction and a second direction.

20. The method of using a windshield wiper lifting system of claim 18, wherein the motor is comprised of an electric motor.
